(19) United States
(12) Patent Application Publication
(10) Pub. No.: US 2026/0302638 A1
(43) Pub. Date: Oct. 1, 2026

(54) ACTIVE DUAL-BAND LIQUID CRYSTAL ARRAY REFLECTIVE STRUCTURE

(71) Applicants: NATIONAL TAIWAN UNIVERSITY OF SCIENCE AND TECHNOLOGY, Taipei City (TW); TMY TECHNOLOGY INC., New Taipei City (TW)

(72) Inventors: Hsi-Hsir CHOU, Taipei City (TW); Ping-Hsun TSAI, Hsinchu City (TW)

(21) Appl. No.: 19/231,085

(22) Filed: Jun. 6, 2025

(30) Foreign Application Priority Data
Mar. 28, 2025 (TW) 114112165

(51) Int. Cl. H01Q 15/14

(52) U.S. Cl. CPC H01Q 15/147

(57) ABSTRACT

The present invention provides an active dual-band liquid crystal array reflective structure. The structure comprises a first substrate layer, a first liquid crystal layer, and a second substrate layer. The first substrate layer and the second substrate layer have four surface units, and components on the different surface units are used to form a first reflective cell unit and a second reflective cell unit. When the first liquid crystal layer is not biased, the first reflective cell unit can be used as a first reflective surface at an operating frequency of 27–29 GHz; when the first liquid crystal layer is biased, the second reflective cell unit can be used as a second reflective surface at an operating frequency of 11–13 GHz.

### TECHNICAL FIELD

The present invention relates to an active dual-band liquid crystal array reflective structure, in particular to a dual-band liquid crystal array reflective surface that is easy to design, dual-phase reconfigurable, easy to implement, and able to achieve the expected frequency band gain and directivity at dual receiving ends.

### BACKGROUND OF THE INVENTION

Early array reflective surfaces were mainly used in radio and radar systems, having geometric structures and electrode units to achieving signal reflection and focusing.

The basic function of array reflection is to control the propagation path of electromagnetic waves through a series of reflective units to achieve signal enhancement, direction control, and beam forming. However, since the curved surface structure is gradually replaced by flat array reflective surfaces due to its high cost in design and public welfare. These reflective units have fixed electrode units or are adjustable (adding lumped elements such as PIN-Diode) to meet different application requirements.

With the advancement of technology, the array reflective surfaces have been widely used in communication, radar, satellites, wireless transmission and the like, playing a vital role in communication and information dissemination in modern society. Their effect on society is mainly reflected in promoting the development and application of communication technology and improving communication quality and efficiency.

For example, in wireless communication, array reflection can effectively increase signal coverage and transmission rate, thereby meeting people's growing communication requirements. In radar systems, the array reflective surfaces can improve the accuracy of target detection and tracking, which is of great significance in the defense and aerospace fields.

Among various types of array reflective surfaces, dual-band liquid crystal array reflective surfaces have multifunctional characteristics and can operate in two different frequency bands and be controlled independently. The growing demand for multifunctional, efficient antennas in modern communication and radar systems has promoted the development of dual-band reflectarrays.

These reflective surfaces are capable of operating at multiple frequencies, thereby enhancing their applicability in a variety of scenarios including satellite communication, wireless communication, and remote sensing. Liquid crystal technology is incorporated to further enhance the adaptability of the reflectarrays by allowing dynamic control of the phase response of the reflective elements.

### SUMMARY OF THE INVENTION

An active dual-band liquid crystal array reflective structure comprises: a first substrate layer, having a first upper surface and a first lower surface; a second substrate layer, having a second upper surface and a second lower surface; a first liquid crystal layer, stacked and connected between the first substrate layer and the second substrate layer; a plurality of first surface units, arranged in an array on the first upper surface, wherein each first surface unit has four first surface frame-shaped patches and a first surface cross-shaped patch, and a first surface rectangular patch is disposed inside the first surface frame-shaped patch; a plurality of second surface units, arranged in an array on the first lower surface, wherein each second surface unit has four tree-shaped patches, every two of which are connected, and each tree-shaped patch has a first conductive part and three second conductive parts, wherein the three second conductive parts are arranged in parallel and are connected in series on the first conductive part, wherein the first conductive part extends along a first direction, the second conductive part extends along a second direction, and the first direction and the second direction are different directions; a plurality of third surface units, arranged in an array on the second upper surface, wherein each third surface unit has four third surface rectangular patches, wherein the edge of each third surface rectangular patch is connected with four third surface metal wires; a plurality of fourth surface units, arranged in an array on the second lower surface, wherein each fourth surface unit is a fourth surface rectangular patch, wherein the first surface frame-shaped patch, the first surface rectangular patch, the first substrate layer, the tree-shaped patch, the first liquid crystal layer, the third surface rectangular patch, the four third surface metal wires connected to the edge of the third surface rectangular patch, and the fourth surface unit form a first reflective cell unit; when the first liquid crystal layer is not biased, the central operating frequency of the first reflective cell unit is between 27 GHz and 29 GHz, wherein the first surface cross-shaped patch, the first substrate layer, the second surface unit, the first liquid crystal layer, the third surface unit, and the fourth surface unit form a second reflective cell unit; when an electromagnetic wave is incident after the first liquid crystal layer is biased, the central operating frequency of the second reflective cell unit is between 11 GHz and 13 GHz.

### BRIEF DESCRIPTION OF DRAWINGS

FIG. 1A is a multi-layer structure schematic diagram of an active dual-band liquid crystal array reflective structure of the present invention.

FIG. 1B is a multi-layer structure schematic cross-sectional view of the active dual-band liquid crystal array reflective structure of the present invention.

FIG. 2A is a schematic diagram showing the cell design of a first surface unit of the active dual-band liquid crystal array reflective structure of the present invention.

FIG. 2B is a schematic diagram showing the cell design of a second surface unit of the active dual-band liquid crystal array reflective structure of the present invention.

FIG. 2C is a schematic diagram showing the cell design of a third surface unit of the active dual-band liquid crystal array reflective structure of the present invention.

FIG. 2D is a schematic diagram showing the cell design of a fourth surface unit of the active dual-band liquid crystal array reflective structure of the present invention.

FIG. 3A is a schematic diagram showing the structure of a first reflective cell unit of the active dual-band liquid crystal array reflective structure of the present invention.

FIG. 3B is a graph showing patch unit size vs. phase of the first reflective cell unit of the active dual-band liquid crystal array reflective structure of the present invention at 28 GHz.

FIG. 3C is a graph showing patch unit size vs. reflection coefficient of the first reflective cell unit of the active dual-band liquid crystal array reflective structure of the present invention at 28 GHz.

FIG. 4A is a schematic diagram showing the structure of a second reflective cell unit of the active dual-band liquid crystal array reflective structure of the present invention.

FIG. 4B is a graph showing patch unit size vs. phase of the second reflective cell unit of the active dual-band liquid crystal array reflective structure of the present invention at 12 GHz.

FIG. 4C is a graph showing patch unit size vs. reflection coefficient of the second reflective cell unit of the active dual-band liquid crystal array reflective structure of the present invention at 12 GHz.

FIG. 5A is a schematic diagram showing a 28 GHz surface array phase distribution of the active dual-band liquid crystal array reflective structure of the present invention.

FIG. 5B is a schematic diagram showing a 12 GHz surface array phase distribution of the active dual-band liquid crystal array reflective structure of the present invention.

FIG. 6A is a polar diagram showing a total gain radiation pattern of the liquid crystal array reflective surface at a frequency band of 28 GHz according to a first implementation of the active dual-band liquid crystal array reflective structure of the present invention.

FIG. 6B is a two-dimensional diagram showing the total gain radiation pattern of the liquid crystal array reflective surface at a frequency band of 28 GHz according to the first implementation of the active dual-band liquid crystal array reflective structure of the present invention.

FIG. 7A is a polar diagram showing a realized gain radiation pattern of the liquid crystal array reflective surface at a frequency band of 28 GHz according to a second implementation of the active dual-band liquid crystal array reflective structure of the present invention.

FIG. 7B is a two-dimensional diagram showing the realized gain radiation pattern of the liquid crystal array reflective surface at a frequency band of 28 GHz according to the second implementation of the active dual-band liquid crystal array reflective structure of the present invention.

FIG. 8A is polar diagram showing a 28 GHz normalized realized gain according to a third implementation of the active dual-band liquid crystal array reflective structure of the present invention.

FIG. 8B is a two-dimensional diagram showing the 28 GHz normalized realized gain according to the third implementation of the active dual-band liquid crystal array reflective structure of the present invention.

FIG. 9A is a polar diagram showing a total gain radiation pattern of the liquid crystal array reflective surface at a frequency band of 12 GHz according to a fourth implementation of the active dual-band liquid crystal array reflective structure of the present invention.

FIG. 9B is a two-dimensional diagram showing the total gain radiation pattern of the liquid crystal array reflective surface at a frequency band of 12GHz according to the fourth implementation of the active dual-band liquid crystal array reflective structure of the present invention.

FIG. 10A is a polar diagram showing a realized gain radiation pattern of the liquid crystal array reflective surface at a frequency band of 12 GHz according to a fifth implementation of the active dual-band liquid crystal array reflective structure of the present invention.

FIG. 10B is a two-dimensional diagram showing the realized gain radiation pattern of the liquid crystal array reflective surface at a frequency band of 12 GHz according to the fifth implementation of the active dual-band liquid crystal array reflective structure of the present invention.

FIG. 11A is polar diagram showing a 12 GHz normalized realized gain according to a sixth implementation of the active dual-band liquid crystal array reflective structure of the present invention.

FIG. 11B is a two-dimensional diagram showing the 12 GHz normalized realized gain according to the sixth implementation of the active dual-band liquid crystal array reflective structure of the present invention.

### DETAILED DESCRIPTION OF THE INVENTION

Other technical contents, features, and effects of the present invention will become apparent from the following detailed description of the preferred embodiments with reference to the drawings.

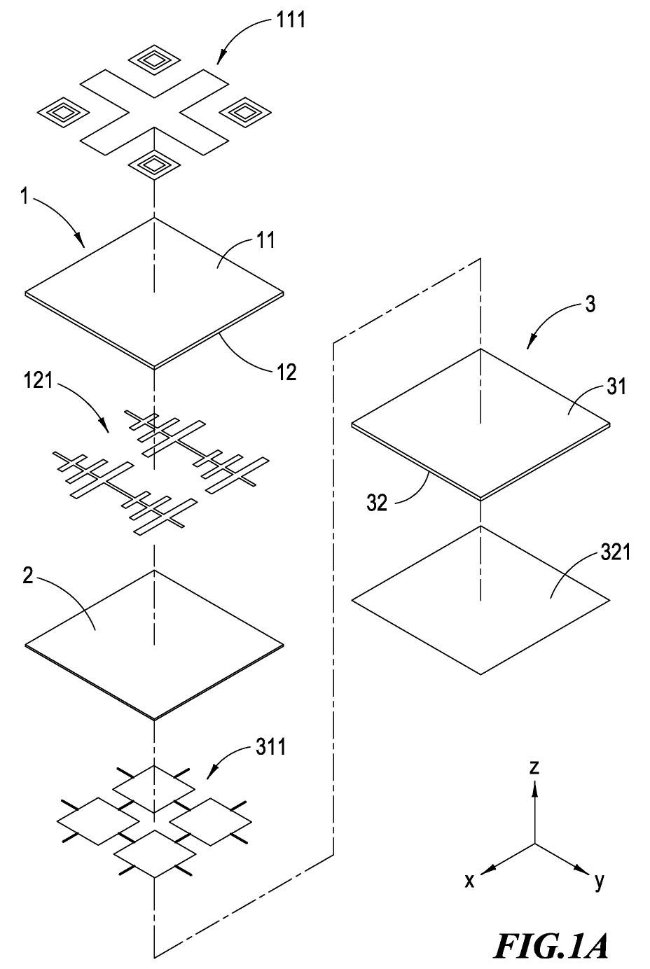

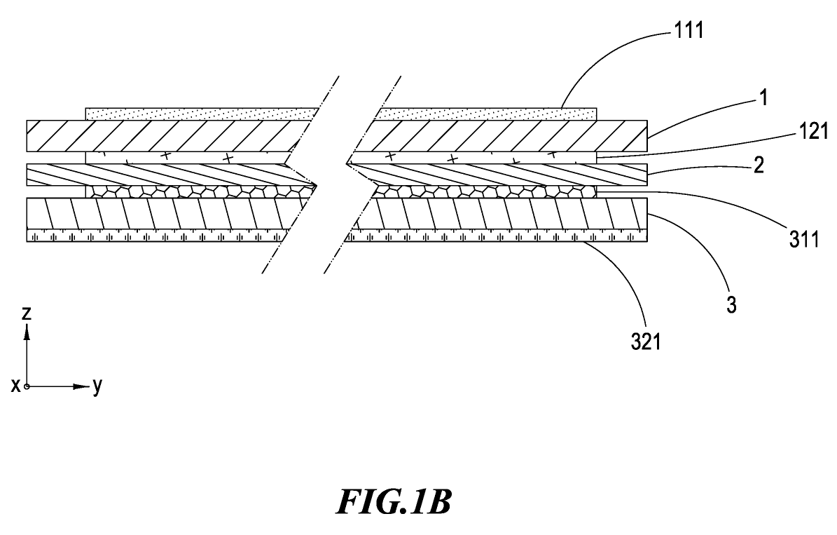

Please refer to FIGS. 1A and 1B, which are a multi-layer structure schematic diagram and a multi-layer structure schematic cross-sectional view of an active dual-band liquid crystal array reflective structure respectively. As shown in the figures, the active dual-band liquid crystal array reflective structure is mainly designed as a two-layer four-sided circuit board. The active dual-band liquid crystal array reflective structure includes a first substrate layer 1, a first liquid crystal layer 2, and a second substrate layer 3, wherein the first liquid crystal layer 2 is stacked and connected between the first substrate layer 1 and the second substrate layer 3.

The first substrate layer 1 and the second substrate layer 3 are high-frequency printed circuit boards with dielectric constant of 3.28–3.32 and loss tangent of 0.002. The thickness of the first substrate layer 1 is 1.516–1.524 mm, and the thickness of the second substrate layer 3 is 0.5065–0.5095 mm. However, the present invention is not limited to this type of circuit board.

As to the first liquid crystal layer 2, the liquid crystal material used in the present embodiments is JNC ZOC-A018XX with a thickness of 0.1 mm with dielectric constant of 2.55–3.76 and loss tangent of 0.004–0.006.

In order to enable the first liquid crystal layer 2 to be biased, since the first liquid crystal layer 2 is sandwiched between the first substrate layer 1 and the second substrate layer 3, in actual implementation in the industry, the first substrate layer 1 and the second substrate layer 3 are both designed with a metal edge on all four edges. Therefore, as long as a bias voltage is applied to the metal edges of the first substrate layer 1 and the second substrate layer 3 above and below the first liquid crystal layer 2 respectively, a voltage difference between the upper and lower surfaces of the entire liquid crystal layer can be created. This feature is well known in the industry so it will not be specially marked in the figures.

The best embodiment of the first liquid crystal layer 2 is that before the first liquid crystal layer is biased, the liquid crystal alignment direction is parallel to the electric field, its dielectric constant is 2.55, and its tangent loss is 0.004; after the first liquid crystal layer is biased, the liquid crystal alignment direction is perpendicular to the electric field, its dielectric constant is 3.76, and its tangent loss is 0.006. However, the present invention is not limited to this type of liquid crystal material.

The first liquid crystal layer 2 has adjustable dielectric properties. By applying an external voltage, the rotation of the liquid crystal molecules can be changed, thereby changing its dielectric constant and changing the phase shift of units.

The first substrate layer 1 has a first upper surface 11 and a first lower surface 12.

The second substrate layer 3 has a second upper surface 31 and a second lower surface 32.

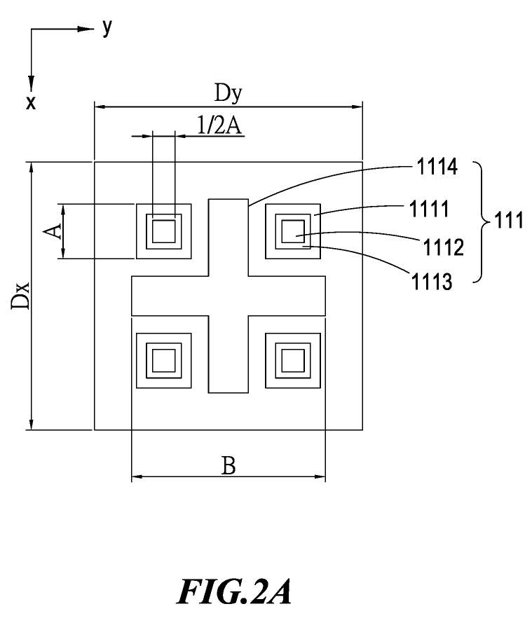

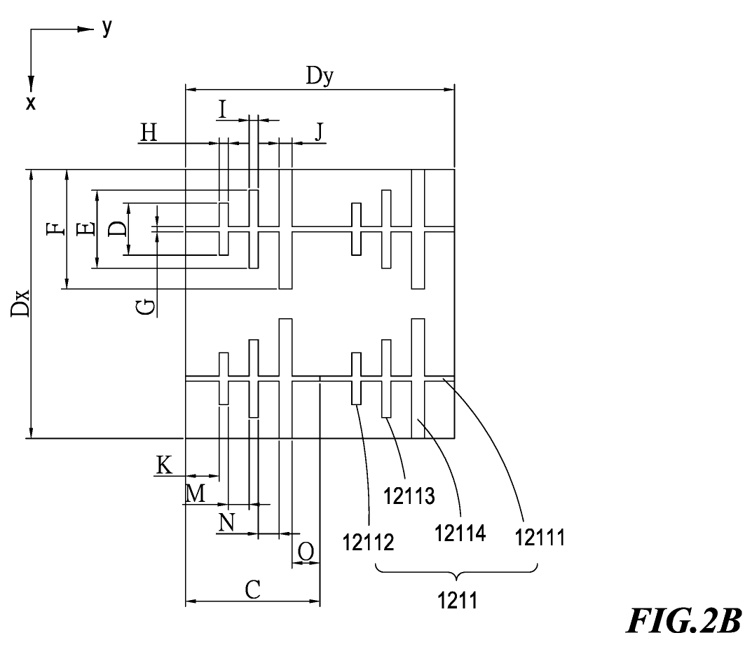

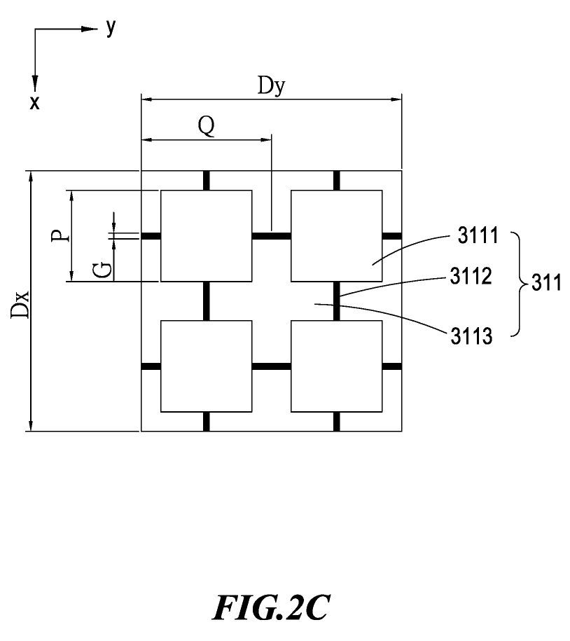

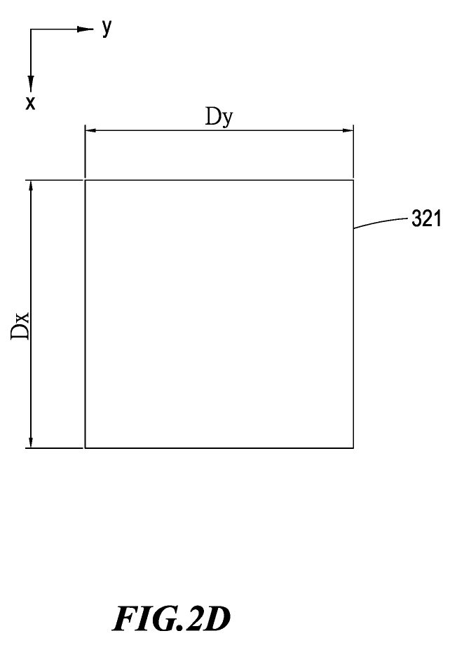

A plurality of first surface units 111 arranged in an array are formed on the first upper surface 11. As shown in FIG. 2A, each first surface unit 111 has four first surface frame-shaped patches 1111 and a first surface cross-shaped patch 1114, and a first surface rectangular patch 1112 is provided inside the first surface frame-shaped patch 1111.

Every four first surface frame-shaped patches are arranged around the first surface cross-shaped patch. A first surface rectangular slit 1113 is provided between the first surface frame-shaped patch 1111 and the first surface rectangular patch 1112.

A plurality of second surface units 121 arranged in an array are formed on the first lower surface 12. As shown in FIGS. 1A and 2B, each second surface unit 121 has four tree-shaped patches 1211, every two of which are connected, and the tree-shaped patch 1211 has a first conductive part 12111 and three second conductive parts 12112, 12113, 12114, wherein the three second conductive parts 12112, 12113, 12114 parallel arranged are connected in series on the first conductive part 12111.

The three second conductive parts 12112, 12113, and 12114 are arranged in ascending order of length and connected in series on the first conductive part 12111, and every two tree-shaped patches 1211 are connected by connecting the second conductive part 12112 with the smallest length of one tree-shaped patch 1211 to the second conductive part 12114 with the largest length of the other tree-shaped patch 1211.

The first conductive part 12111 extends along a first direction (y direction), and the second conductive part extends along a second direction (x direction). The first direction and the second direction are different (the two directions are not parallel).

A plurality of third surface units 311 arranged in an array are formed on the second upper surface 31. As shown in FIG. 2C, each third surface unit 311 has four third surface rectangular patches 3111, wherein the edge of each third surface rectangular patch 3111 is connected with four third surface metal wires 3112.

Every four third surface rectangular patches 3111 and the third surface metal wire 3112 surrounds a third surface cross-shaped opening 3113.

A plurality of fourth surface units arranged in an array are formed on the second lower surface 32. As shown in FIG. 2D , the fourth surface unit is a fourth surface rectangular patch 321, which is used as a ground to ensure total reflection of electromagnetic waves.

The first surface unit, the second surface unit, the third surface unit, and the fourth surface unit are formed of a metal material (such as copper foil with a thickness of 0.0017 mm).

The first substrate layer 1, the first liquid crystal layer 2, and the second substrate layer 3 are stacked to form the active dual-band liquid crystal array reflective structure.

As shown in FIG. 2A, the first upper surface has a plurality of regular rectangular units (Dₓ is 12 mm, D_{y} is 12 mm), and the original metal layer (such as copper foil) of the first upper surface 11 is etched to form a plurality of first surface units 111 on the first upper surface 111.

Each first surface unit 111 is designed with first surface frame-shaped patches 1111, first surface rectangular patches 1112, first surface rectangular slits 1113, and a first surface cross-shaped patch 1114.

The length and width of the first surface frame-shaped patch 1111 are 1–3.8 mm (A is 1–3.8 mm).

The length and width of the first surface rectangular patch 1112 are 0.4–1.52 mm.

The first surface cross-shaped patch 1114 has a first longitudinal portion and a first transverse portion. The lengths of the first longitudinal portion and the first transverse portion are 2–10 mm (B is 2–10 mm).

As shown in FIG. 2B , the first lower surface 12 has a plurality of regular rectangular units (Dₓ is 12 mm, D_{y} is 12 mm), and the original metal layer (such as copper foil) of the first lower surface 12 is etched to form a plurality of second surface units 121 on the first lower surface 121.

Each second surface unit 121 is designed with four tree-shaped patches 1211, wherein each tree-shaped patch 1211 has a first conductive part 12111 and three second conductive parts 12112, 12113, 12114.

The length of the first conductive part 12111 is 6 mm (C is 6 mm), and the width of the first conductive part 12111 is 0.1 mm; the other dimensions thereof are as follows: D=1.55–1.6 mm, E=2.35–2.4 mm, F=2.75–2.8 mm, H=0.25–0.3 mm, I=0.45–0.5 mm, J=0.55–0.6 mm, K=1.15–1.2 mm, M=1.2–1.25 mm, N=0.6–0.65 mm, O=1.45–1.5 mm, and G=0.05–0.1 mm.

As shown in FIG. 2C , the second upper surface 31 has a plurality of rectangular units (Dₓ is 12 mm, D_{y} is 12 mm), and the original metal layer (such as copper foil) of the second upper surface 31 is etched to form a plurality of third surface units 311 on the second upper surface 31.

Each third surface unit 311 comprises third surface rectangular patches 3111, third surface metal wires 3112, and a third surface cross-shaped opening 3113.

The length and width of the third surface rectangular patch 3111 are 3.75-3.8 mm (P).

The length of the third surface metal wire 3112 is 5.95-6 mm (Q), and the width thereof is 0.05-0.1 mm (G).

As shown in FIG. 2D ,the second lower surface 32 has a plurality of regular rectangular units (Dₓ is 12 mm, D_{y} is 12 mm), and the original metal layer (such as copper foil) of the second lower surface 32 is etched to form a plurality of fourth surface units on the second lower surface 32.

Each fourth surface unit is a fourth surface rectangular patch 321, and the length and width of the fourth surface rectangular patch are 1.15-1.2 mm.

A unit designed for 12 GHz in the present invention is symmetrical cross-shaped patches with a unit size of 12mm while a unit designed for 28 GHz is symmetrical double ring-shaped patches with a unit size of 6mm.

After forming an array in the present invention, the number of 28GHz patch units will be four times the number of 12GHz patch units so the beamforming effect will be better. In addition, the maximum size of the 28GHz patch units is designed to be 3.75-3.8 mm. The purpose is not to connect with the 12GHz unit to prevent the two units from coupling with each other.

In the present invention, the liquid crystal layer is not biased for the 28 GHz unit, and the liquid crystal layer is biased for the 12 GHz unit. Furthermore, the sizes of the two elements are approximately a half-wavelength to prevent grating-lobe interference.

The conductive patches (the second surface unit 121, the third surface unit 311) of the present invention are arranged above and below the first liquid crystal layer 2 with fixed shapes.

The tree-shaped patch 1211 in the present invention is an upper patch consisting of three parallel unequal electric dipole patches (the second conductive parts 12112, 12113, 12114). These parallel unequal electric dipole patches are connected through a bias line (the first conductive part 12111) to ensure that the voltage on each unit is consistent.

The third surface unit of the present invention has a square patch with 4 protrusions (the third surface rectangular patch 3111 and the third surface metal wires 3112) so that each patch can be connected to each other.

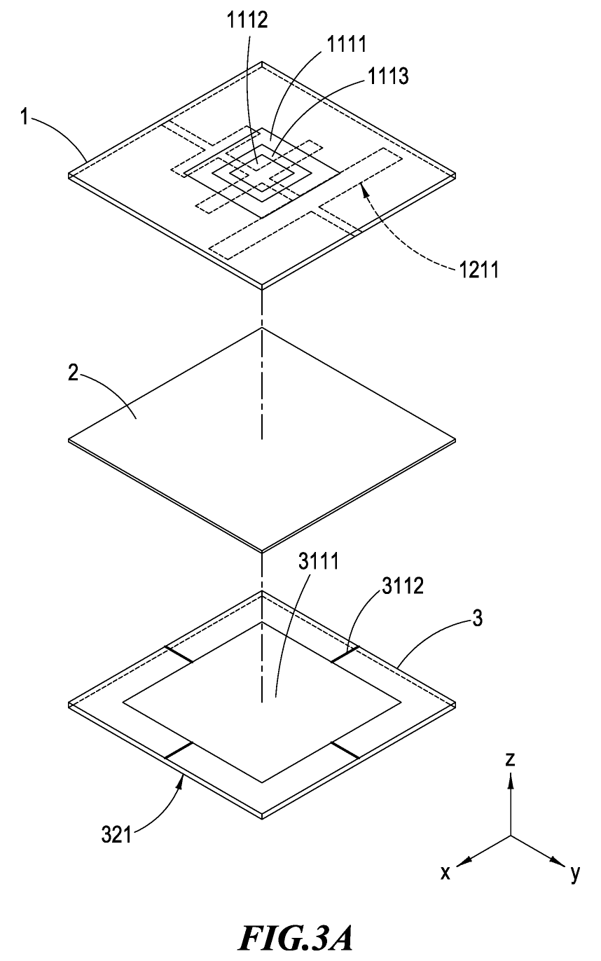

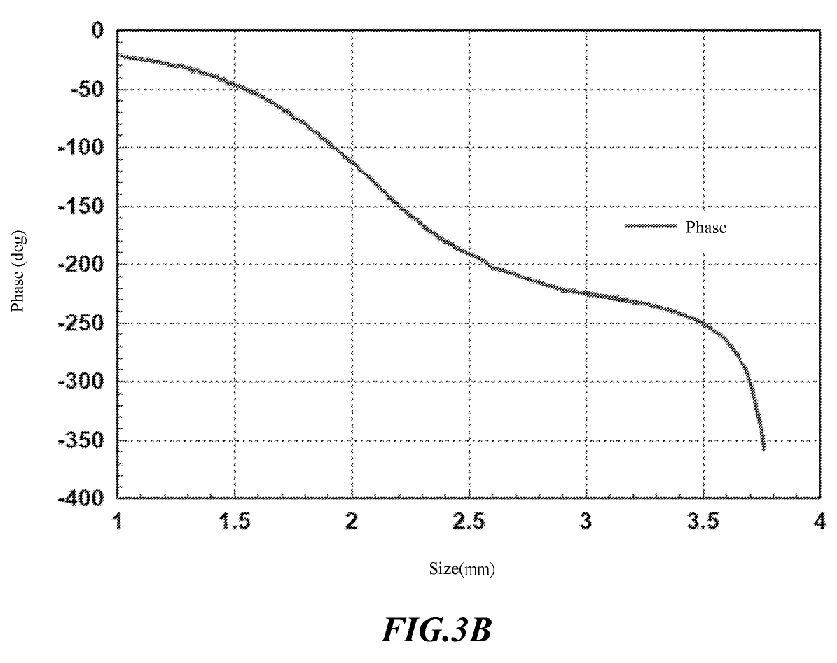

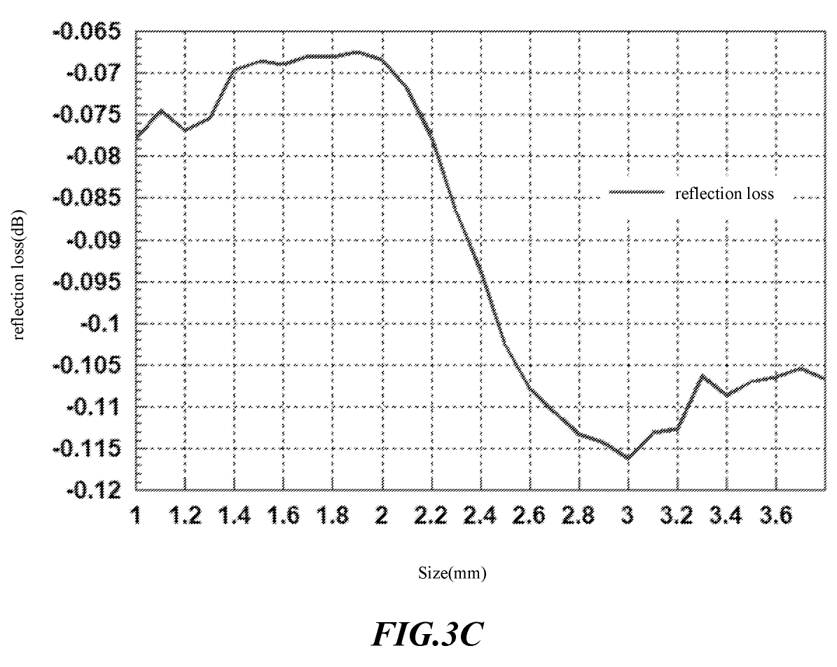

As shown in FIG. 3A, the first surface frame-shaped patch 1111, the first surface rectangular patch 1112, the first substrate layer 1, the tree-shaped patch 1211, the first liquid crystal layer 2, the third surface rectangular patch 3111, the four third surface metal wires 3112 connected to the edge of the third surface rectangular patch 3111, and the fourth surface rectangular patch 321 of the fourth surface unit form a first reflective cell unit. When the first liquid crystal layer 2 is not biased, the central operating frequency of the first reflective cell unit is between 27 GHz and 29 GHz.

The center point of the first surface rectangular patch 1112 corresponds to the intersection of the first conductive part 12111 and the second conductive part 12113.

To meet different operating frequencies, the first surface frame-shaped patch 1111, the first surface rectangular patch 1112, and the tree-shaped patch 1211 of the present invention correspond to different operating frequencies. They are designed to be less than half the wavelength, but their internal detailed parameters need to be fine-tuned with the wavelength, and the fine-tuning range is not limited.

When the first liquid crystal layer 2 is not biased, the first reflective cell unit can be used as a first reflective surface at the central operating frequency of 27-29 GHz.

As shown in FIG. 3B , the incident wave in the present invention is assumed to have an incident angle of 30 degrees, and the reflection phase at 28 GHz is shown in the figure. It can be seen that as the double ring and cross-shaped patches change in size with its corresponding liquid crystal dielectric constant, the phase change will exceed 330 degrees.

As shown in FIG. 3C , the reflection coefficient at 28 GHz can be observed during the change of the patches (the first surface frame-shaped patch 1111 and the first surface rectangular patch 1112) in size, wherein the S11 parameter is always kept below 2 dB, indicating that the loss is very low. This means the unit has a nearly perfect reflection.

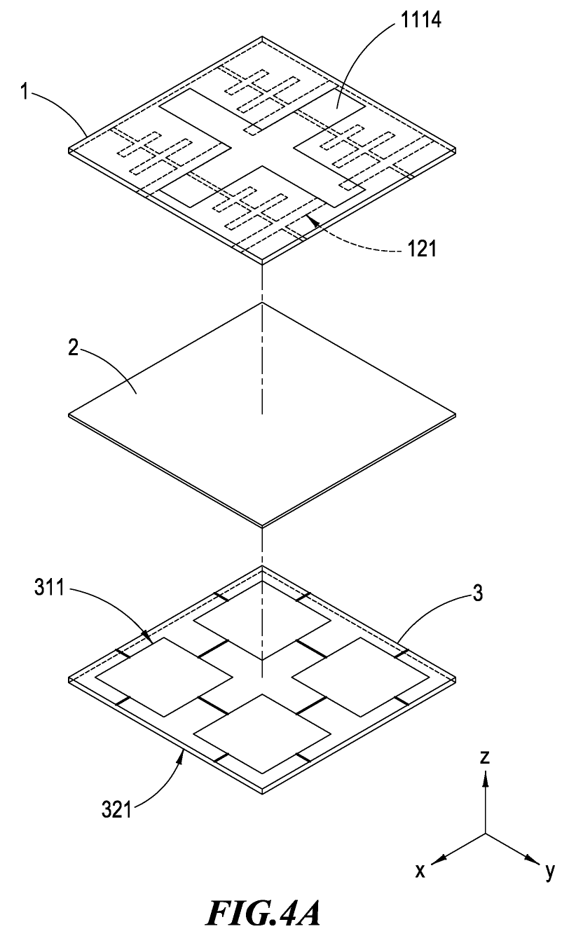

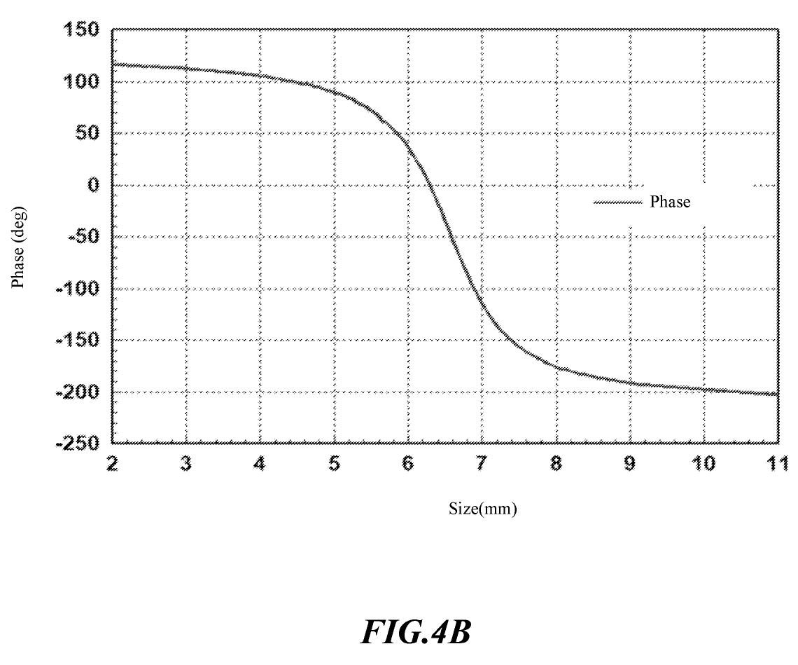

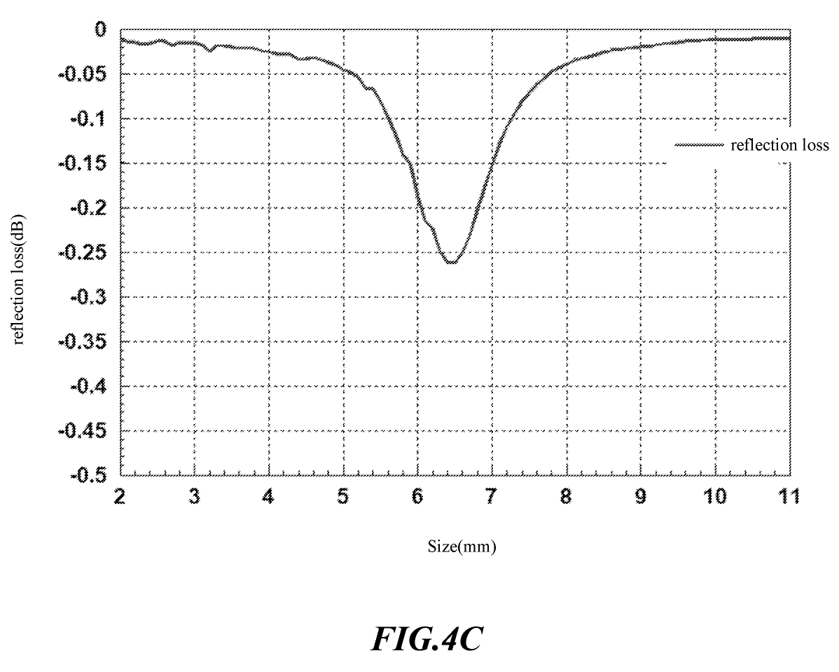

As shown in FIG. 4A , the first surface cross-shaped patch 1114, the first substrate layer 1, the second surface unit 121, the first liquid crystal layer 2, the third surface unit 311, and the fourth surface rectangular patch 321 of the fourth surface unit form a second reflective cell unit. When an electromagnetic wave is incident after the first liquid crystal layer 2 is biased, the central operating frequency of the second reflective cell unit is between 11 GHz and 13 GHz.

The center point of the first surface cross-shaped patch 1114 corresponds to the relative center position between the four tree-shaped patches 1211.

To meet different operating frequencies, the first surface cross-shaped patch 1114 and the tree-shaped patches of the present invention correspond to different operating frequencies. They are designed to be less than half the wavelength, but their internal detailed parameters need to be fine-tuned with the wavelength, and the fine-tuning range is not limited.

When the first liquid crystal layer 2 is biased, the second reflective cell unit can be used as a second reflective surface at the central operating frequency of 11-13 GHz.

Since the second surface unit 121 and the third surface unit 311 are connected to different voltages, there is a voltage difference between them. The magnitude of the electric field formed by the voltage difference is the main factor controlling the deflection of the liquid crystal molecules.

The first liquid crystal layer 2 is located between the second surface units 121 and the third surface units 311. The function of the upper and lower conductive layers is that when the electric field is zero (the external voltage is zero), the liquid crystal molecules are evenly arranged; when the bias voltage is applied from 0 volt, the liquid crystal molecules between the units are deflected, the dielectric constant thereof is changed, and the reflection phase of the electromagnetic wave is also changed. Therefore, with the dual-band patches of the first surface unit 111 designed for different bias voltages of the liquid crystal, the first frequency band corresponds to the first bias value (e.g. 0V), and the second frequency band corresponds to the second bias value (e.g. 10V); then, the sizes of the units are adjusted by calculating the incident and reflection angles so that a specific frequency band is reflected at a specific position, and it can operates on two different frequency bands with independent control and beamforming.

As shown in FIG. 4B , the incident wave in the present invention is assumed to have an incident angle of 30 degrees, and the reflection phase at 12 GHz is shown in the figure. It can be seen that as the double ring and cross-shaped patches change in size with its corresponding liquid crystal dielectric constant, the phase change will exceed 330 degrees.

As shown in FIG. 4C , the reflection coefficient at 12 GHz can be observed during the change of the patch (the first surface cross-shaped patch 1114) in size, wherein the S11 parameter is always kept below 2 dB, indicating that the loss is very low. This means the unit has a nearly perfect reflection.

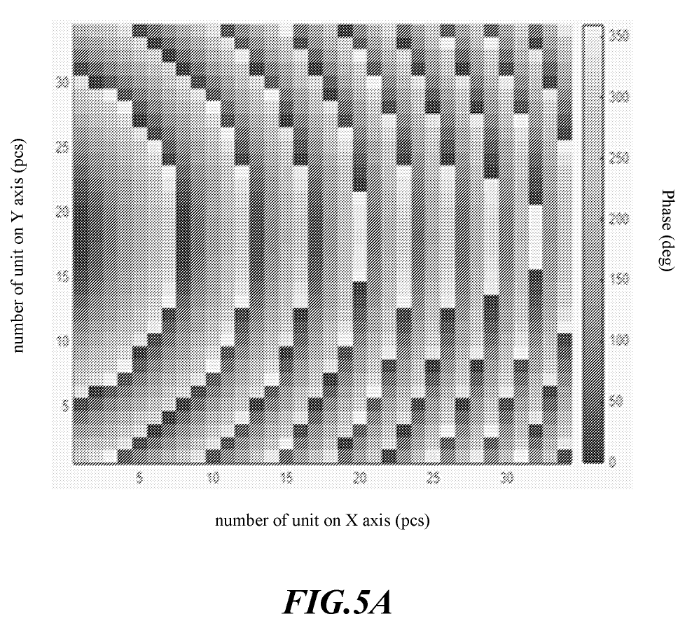

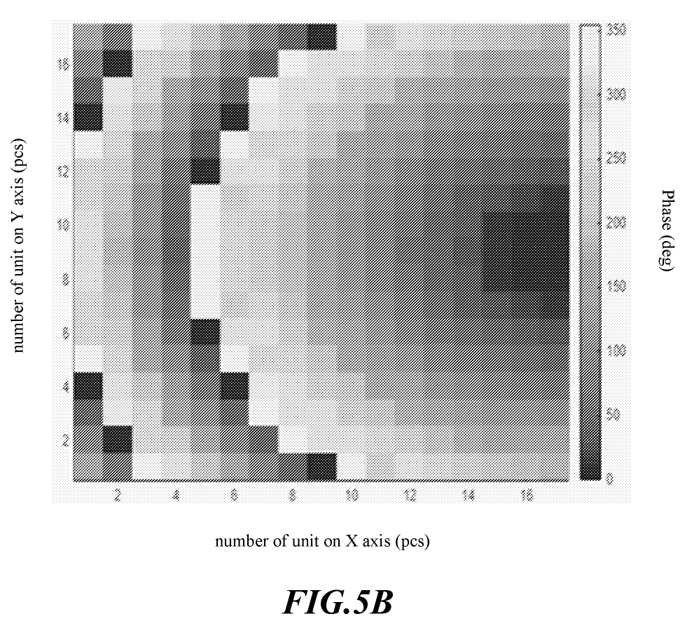

As shown in FIG. 5A, it is a simulated ideal phase distribution diagram of the present invention at 28 GHz, in which the grayscale color gradient represents the phase value from 0 to 360 degrees, and x and y axes represent the number of unit of cells; as shown in FIG. 5B, it is a simulated ideal phase distribution diagram of the present invention at 12 GHz, in which the grayscale color gradient represents the phase value from 0 to 360 degrees, and x and y axes represent the number of unit of cells.

The phase required for the above-mentioned simulated ideal phase distribution (phase compensation) can be calculated through a formula, and the calculation behavior described above is certainly known to those skilled in the art so it will not be further described.

There are six implementations described below, in the present invention.

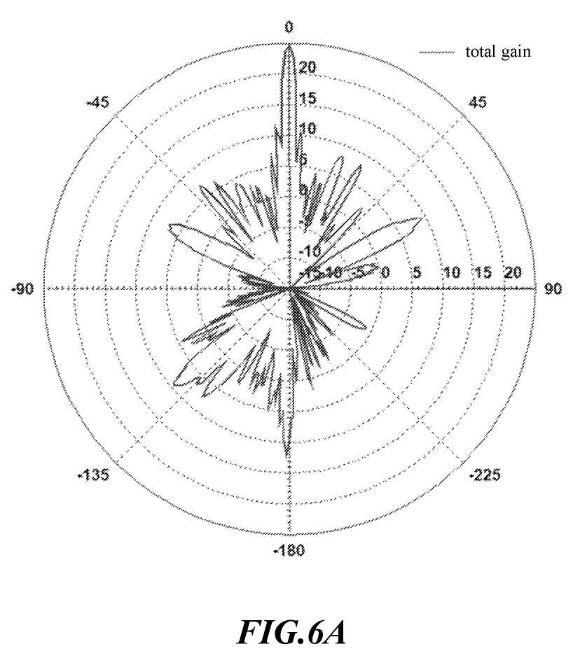

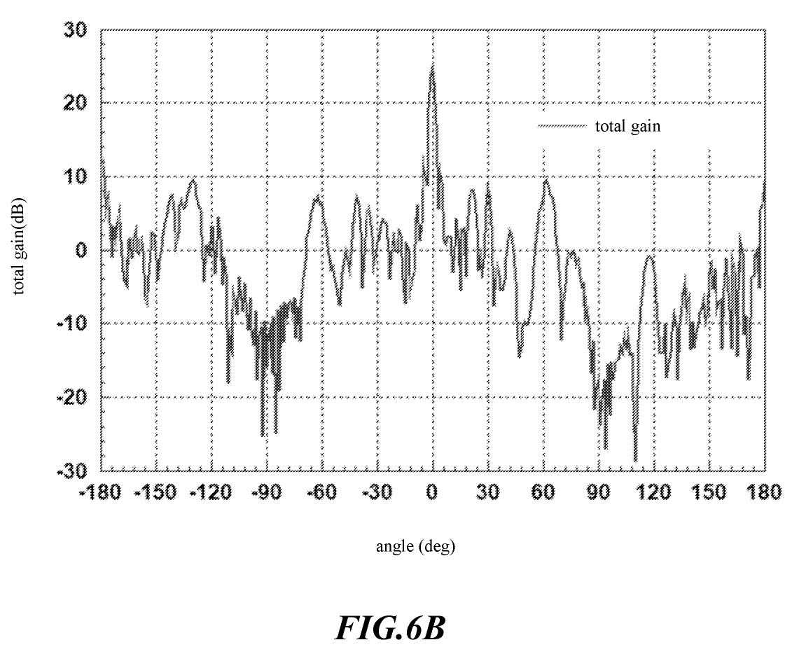

The first implementation is described as follows:
(1) as shown in FIG. 6A , it is a polar diagram of a total gain radiation pattern of the dual-band liquid crystal array reflective surface; it can be seen that in the 28GHz frequency band, when the liquid crystal layer is not biased, the maximum gain is 25.34dB at a reflection angle of 0 degree, and the -3dB beam width is 3 degrees;
(2) as shown in FIG. 6B, it is a two-dimensional diagram of the total gain radiation pattern, where the x-axis represents the change in theta in spherical coordinates and the y-axis represents the total gain value.

As to the 28GHz liquid crystal array reflective surface of the present invention, a feed source is incident at an oblique angle and a distance of 300mm and simulated as a plane wave incident behavior. In practice, the feed source is incident on a parabolic reflective surface to make the reflected plane wave reach the designed reflective surface. In addition, the antenna used in the present invention is linearly polarized, the -3dB beam widths in the E plane and H plane are similar, and a highly directional pencil beam can be achieved.

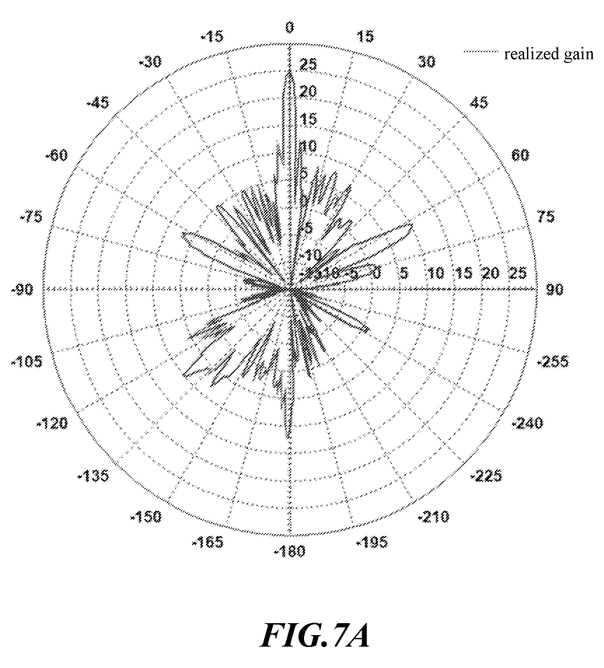

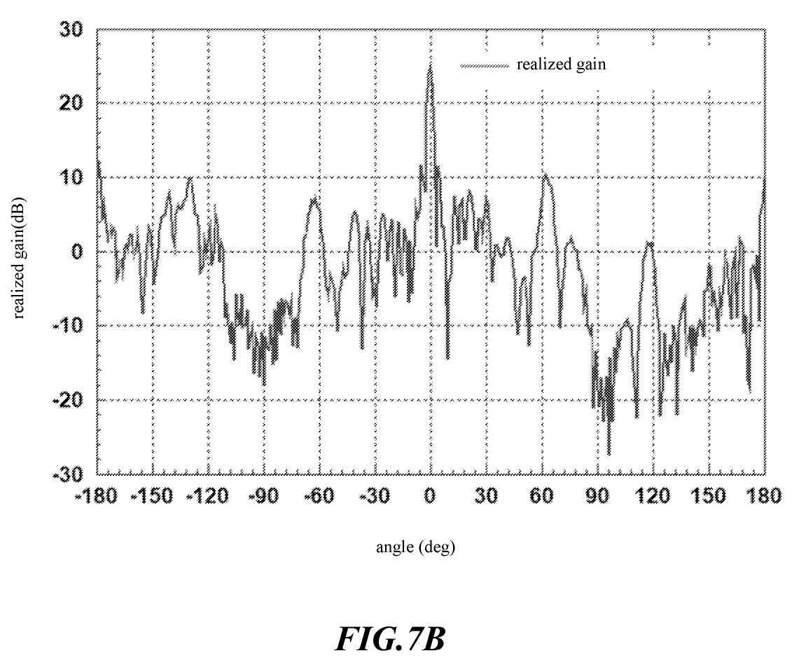

The second implementation is described as follows:
(1) as shown in FIG. 7A, it is a polar diagram that is used to evaluate the actual performance of the reflectarray system and determine the amount of signal collected and reflected;
(2) as shown in FIG. 7B, it is a two-dimensional diagram of the realized gain of the dual-band liquid crystal array reflective surface at 28GHz;
(3) as can be seen from the above figure, the highest point is 25.2dB, which differs from the total gain value by less than 1dB; this is because the substrate loss is very low, and the conductive patch is set to be a perfect conductor (PEC).

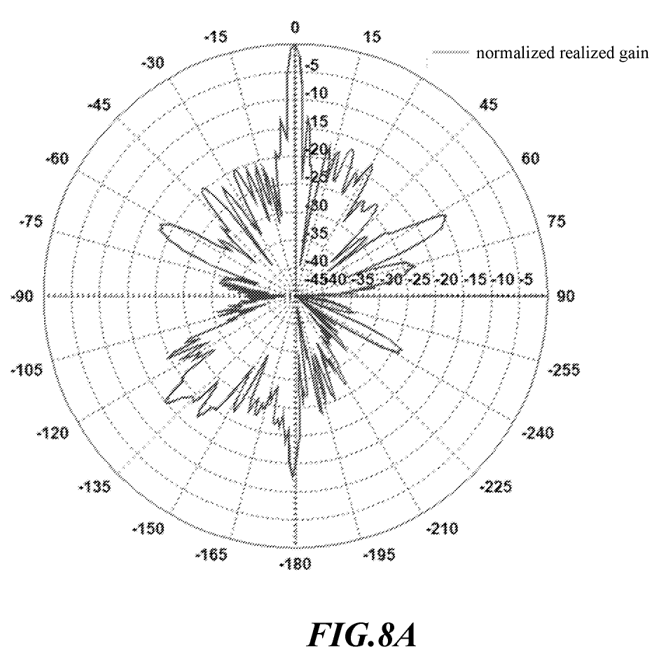

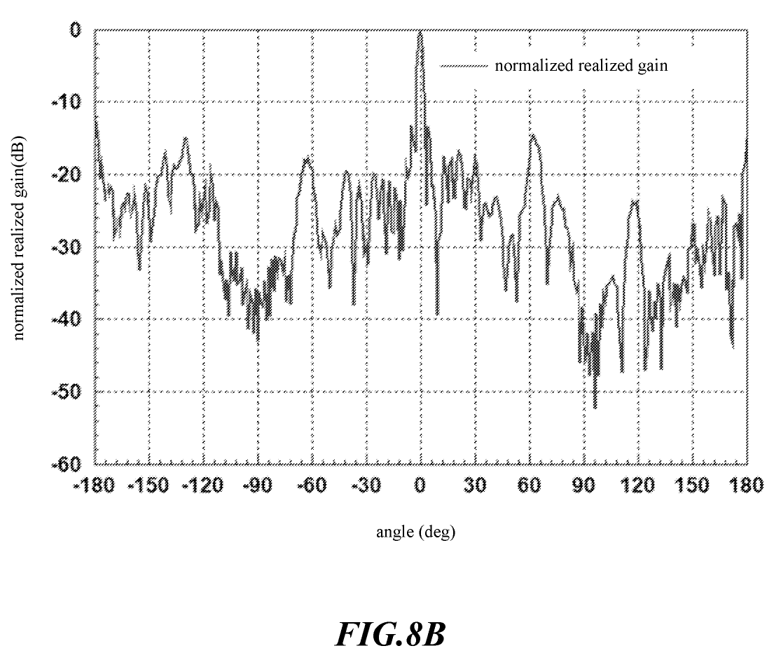

The third implementation is described as follows:
(1) as shown in FIG. 8A, it is a polar diagram of the normalized realized gain; it can be seen from the figure that except for the main beam, the side lobes are all below -10dB;
(2) as shown in FIG. 8B, it is a two-dimensional diagram of the normalized realized gain; it can be seen that the side lobes differ from the main beam by more than 10 dB, and the side lobe interference is low.

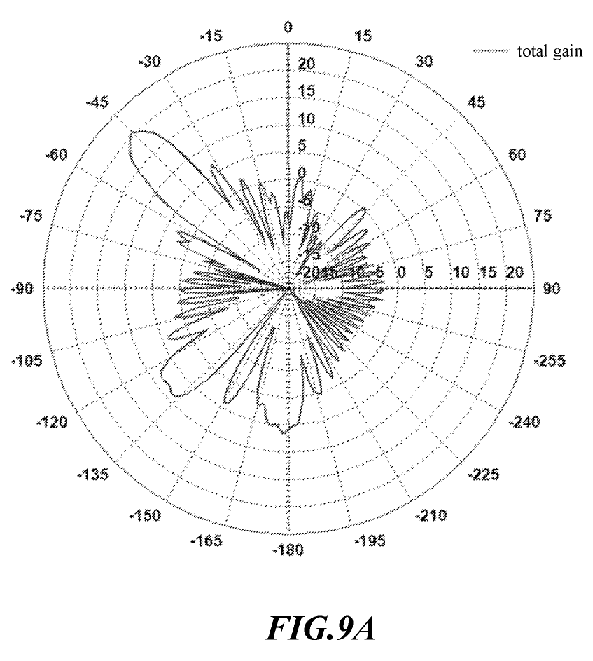

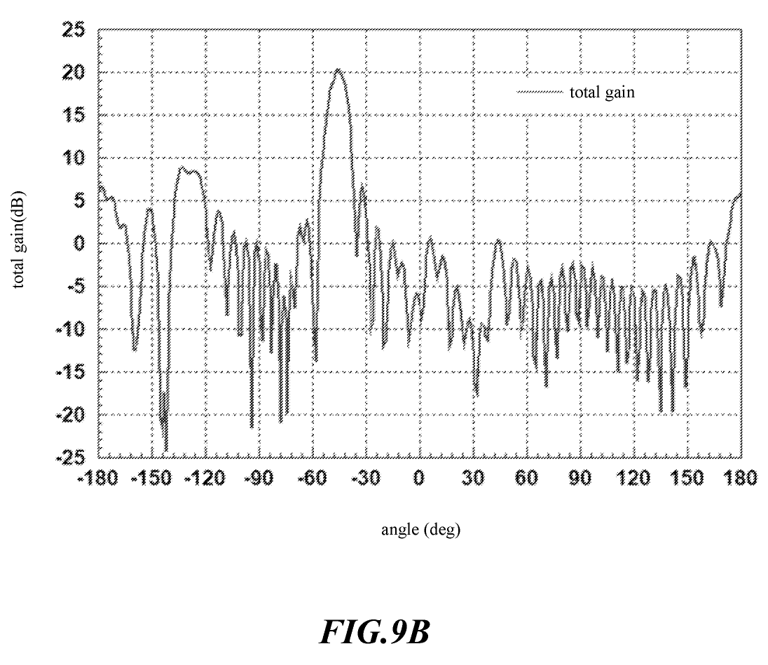

The fourth implementation is described as follows:
(1) as shown in FIG. 9A , it is a polar diagram of the total gain radiation pattern of the liquid crystal array reflective surface at 12 GHz; it can be seen that when the liquid crystal layer is biased, the maximum gain is 20.3 dB at a reflection angle of 45 degrees, and the -3 dB beam width is 9.6 degrees;
(2) as shown in FIG. 9B, it is a two-dimensional diagram of the total gain radiation pattern, where the x-axis represents the change in theta in spherical coordinates, and the y-axis represents the total gain value.

As to the 12GHz band liquid crystal array reflective surface of the present invention, the total gain is about 20dB, which is lower than that of the 28GHz band; this is because the reflection angle is larger and the number of unit is smaller; in addition, the -3dB beam width of the feed source is larger, and the required array surface is also larger; since the computer performance is not enough to run a larger array, the reflective surface that meets the requirements will be the main focus, and the high performance is the supplement.

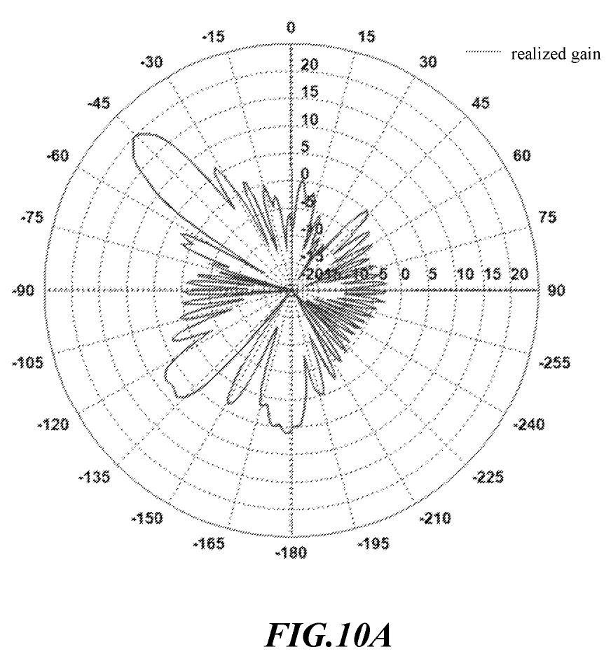

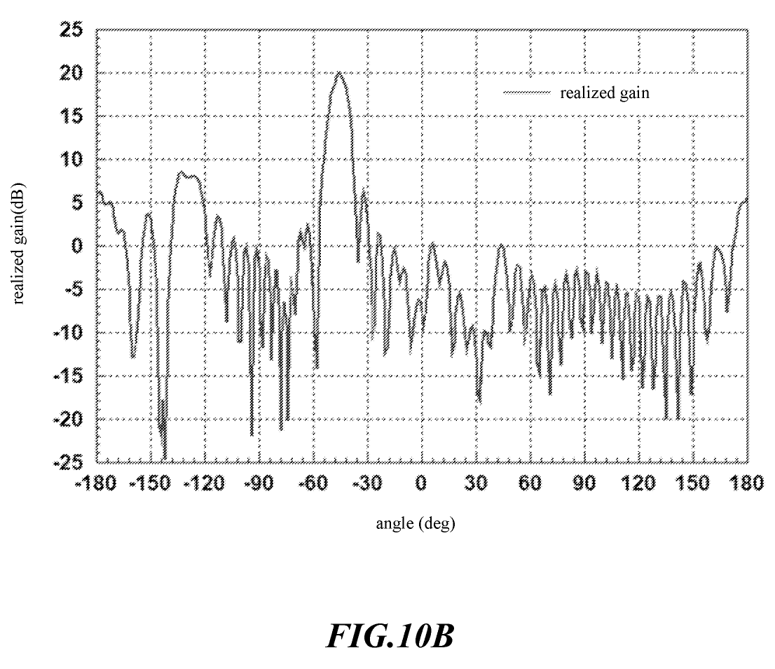

The fifth implementation is described as follows:
(1) as shown in FIG. 10A, it is a polar diagram;
(2) as shown in FIG. 10B, it shows a two-dimensional diagram of the total gain of the dual-band liquid crystal array reflective surface at28GHz;
(3) as can be seen from the above figure, it is used to evaluate the actual performance of the reflect array system and determine the amount of signal collected and reflected; the highest point in the diagram is 25.2dB, which differs from the total gain value by less than 1 dB; this is because the substrate loss is very low, and the conductive patch is set to be a perfect conductor (PEC).

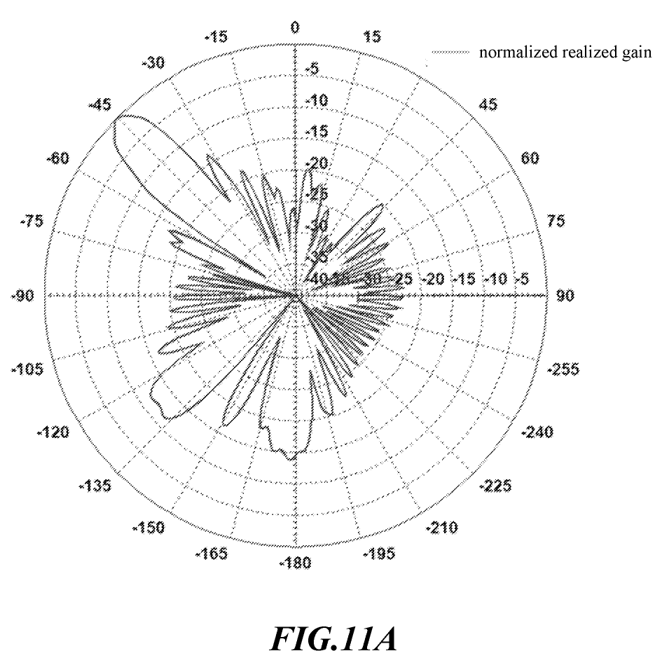

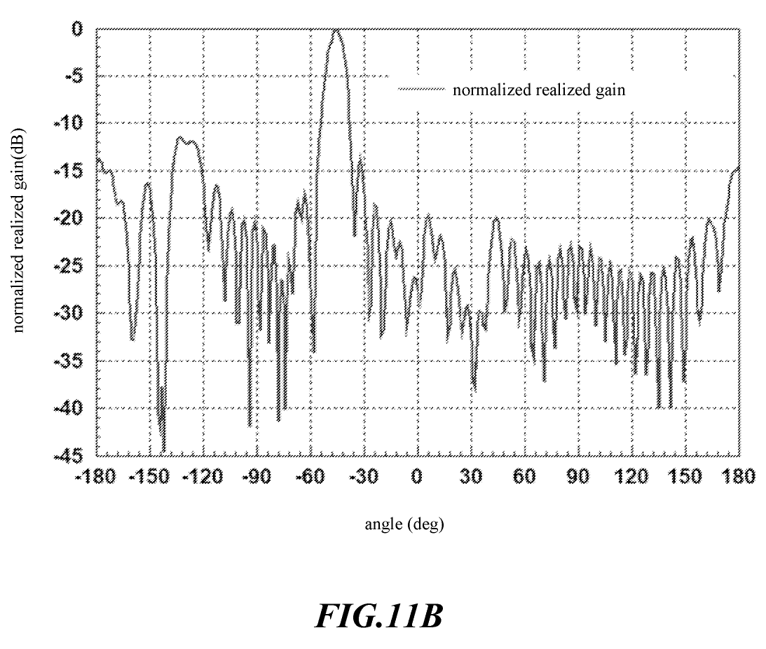

The sixth implementation is described as follows:
(1) as shown in FIG. 11A, it is a polar diagram of the normalized realized gain; it can be seen from the figure that except for the main beam, the side lobes are all below -10dB;
(2) as shown in FIG. 11B, it is a two-dimensional diagram of the normalized realized gain; it can be seen that the side lobes differ from the main beam by more than 10 dB, and the side lobe interference is low.

Compared with other conventional technologies, the active dual-band liquid crystal array reflective structure provided by the present invention has the following advantages:
(1) the present invention proposes a dual-band liquid crystal array reflective surface structure, wherein the structure can perform different dielectric parameter modulation on the entire liquid crystal layer to achieve the expected gain and directivity at two fixed receiving ends;
(2) the dual-band liquid crystal array reflective surface in the present invention mainly utilizes the maximum horizontal and vertical dielectric constants of liquid crystal to make the array respond to two corresponding frequency bands; different from the general dual-band array surface, the purpose of the present invention is to have a higher degree of non-coupling between the dual bands and use liquid crystal to achieve a similar dual-band switch effect;
(3) the operational principle of the dual-band liquid crystal array reflective surface in the present invention is based on the ability to dynamically control the phase of reflected waves in two different frequency bands using liquid crystal technology; this advanced antenna design has significant advantages in flexibility, efficiency, and adaptability, making it ideal for modern communication and radar application; by utilizing the tunable property and control system of of liquid crystal, the dual-band reflectarray can achieve high performance and independent operation at multiple frequencies, meeting the growing demands of next-generation wireless systems;
(4) compared with the conventional technology, the structure proposed in the present invention is much simpler than independent unit phase control and has been improved and optimized in circuit design and process cost; although the performance of the structure is inferior to that of beam scanning, the fixed dual-band reflection phase makes control and calculation relatively easy, and the appropriate reflection angle can have more applications in the living environment; in addition, the selectivity of the frequency band has also become a major feature; compared with the general dual-band reflective surface, liquid crystal can control the passage of a certain band in real time, rather than reflect any frequency band all the time; in the environment with large-scale coverage of 5G and low-orbit communications, this selective design can ensure confidentiality in any frequency band;
(5) in the conventional technology, controlling liquid crystal layer units individually results in higher unit loss and cannot meet the low loss requirement; controlling the change in bias voltage requires extreme precision, and consequently, not only is it difficult to design, but its success rate is also greatly reduced in actual operation due to external factors and errors; reconfiguration of the reflection phase is also difficult to achieve; therefore, compared with individual liquid crystal unit control, the present invention is easy to design, dual-phase reconfigurable, easy to implement, and able to achieve the expected frequency band gain and directivity at the dual receiving ends.

The present invention has been disclosed through the above-mentioned embodiments, but this is not intended to limit the present invention. Any person having ordinary skill in the art can make some changes and modifications without departing from the spirit and scope of the present invention after understanding the foregoing technical features and embodiments of the present invention. Therefore, the patent protection scope of the present invention should be subject to the claims attached to this specification.

What is claimed is:

1. An active dual-band liquid crystal array reflective structure, comprising:
a first substrate layer, having a first upper surface and a first lower surface;
a second substrate layer, having a second upper surface and a second lower surface;
a first liquid crystal layer, stacked and connected between the first substrate layer and the second substrate layer;
a plurality of first surface units, arranged in an array on the first upper surface, wherein each first surface unit has four first surface frame-shaped patches and a first surface cross-shaped patch, and a first surface rectangular patch is disposed inside the first surface frame-shaped patch;
a plurality of second surface units, arranged in an array on the first lower surface, wherein each second surface unit has four tree-shaped patches, every two of which are connected, and each tree-shaped patch has a first conductive part and three second conductive parts, wherein the three second conductive parts are arranged in parallel and are connected in series on the first conductive part, wherein the first conductive part extends along a first direction, the second conductive part extends along a second direction, and the first direction and the second direction are different directions;
a plurality of third surface units, arranged in an array on the second upper surface, wherein each third surface unit has four third surface rectangular patches, wherein the edge of each third surface rectangular patch is connected with four third surface metal wires; and
a plurality of fourth surface units, arranged in an array on the second lower surface, wherein each fourth surface unit is a fourth surface rectangular patch,
wherein the first surface frame-shaped patch, the first surface rectangular patch, the first substrate layer, the tree-shaped patch, the first liquid crystal layer, the third surface rectangular patch, the four third surface metal wires connected to the edge of the third surface rectangular patch, and the fourth surface unit form a first reflective cell unit; when the first liquid crystal layer is not biased, the central operating frequency of the first reflective cell unit is between 27 GHz and 29 GHz,
wherein the first surface cross-shaped patch, the first substrate layer, the second surface unit, the first liquid crystal layer, the third surface unit, and the fourth surface unit form a second reflective cell unit; when an electromagnetic wave is incident after the first liquid crystal layer is biased, the central operating frequency of the second reflective cell unit is between 11 GHz and 13 GHz.

2. The active dual-band liquid crystal array reflective structure of claim 1, wherein every four first surface frame-shaped patches are arranged around the first surface cross-shaped patch, and a first surface rectangular slit is provided between the first surface frame-shaped patch and the first surface rectangular patch.

3. The active dual-band liquid crystal array reflective structure of claim 1, wherein the three second conductive parts are arranged in ascending order of length and connected in series on the first conductive part, and every two tree-shaped patches are connected, wherein the second conductive part with the smallest length of one tree-shaped patch is connected to the second conductive part with the largest length of the other tree-shaped patch.

4. The active dual-band liquid crystal array reflective structure of claim 1, wherein every four third surface rectangular patches and the third surface metal wire surrounds a third surface cross-shaped opening.

5. The active dual-band liquid crystal array reflective structure of claim 1, wherein the first surface unit, the second surface unit, the third surface unit, and the fourth surface unit are formed of a metal material.

6. The active dual-band liquid crystal array reflective structure of claim 1, wherein before and after the first liquid crystal layer is biased, the dielectric constant of the first liquid crystal layer is 2.55-3.76, and the tangent loss is 0.004-0.006.

7. The active dual-band liquid crystal array reflective structure of claim 1, wherein the length and width of the first surface frame-shaped patch are 1-3.8 mm, and the length and width of the first surface rectangular patch are 0.4-1.52 mm.

8. The active dual-band liquid crystal array reflective structure of claim 1, wherein the first surface cross-shaped patch has a first longitudinal portion and a first transverse portion, and the lengths of the first longitudinal portion and the first transverse portion are 2-11 mm.

9. The active dual-band liquid crystal array reflective structure of claim 1, wherein when the first liquid crystal layer is not biased, the first reflective cell unit can be used as a first reflective surface at the central operating frequency of 27-29 GHz; when the first liquid crystal layer is biased, the second reflective cell unit can be used as a second reflective surface at the central operating frequency of 11-13 GHz.
